(19) United States
(12) Patent Application Publication
(10) Pub. No.: US 2024/0331559 A1
(43) Pub. Date: Oct. 3, 2024

(54) Self Sufficiency Hub

(71) Applicant: Radesha Odessa Barnes, Woodbridge, VA (US)

(72) Inventor: Radesha Odessa Barnes, Woodbridge, VA (US)

(21) Appl. No.: 18/418,309

(22) Filed: Apr. 20, 2024

Related U.S. Application Data
(60) Provisional application No. 63/481,864, filed on Jan. 27, 2023.

(51) Int. Cl. G09B 5/08

(52) U.S. Cl. CPC G09B 5/08

(57) ABSTRACT

A centralized method and system for online self-sufficiency education. A Family Self Sufficiency (FSS) participant client will log into a host system to engage in an instruction session. The host will assign a list of potential courses for FSS participants to choose from. A predetermined lesson plan to establish goals for a certificate completion. The lesson plan and Participant profile will be stored on the host system. Goals for studying and completion of goal will also be listed on the host system and stored in the FSS participant profile. The FSS Participant profile will be used to determine study goals for each FSS participant. The profile can be interactive and manipulated by the FSS participant via the participant's computer or mobile device operated. The learning modules will consist of reading, visual, aural, logical, social, solitary, verbal, physical learning methods appealing to the various learning styles of the individual to engage learning. There will be means of online workshops, live seminars, and learning courses comprised of videos, asynchronous materials that will guide, advise, and educate participants through the course.

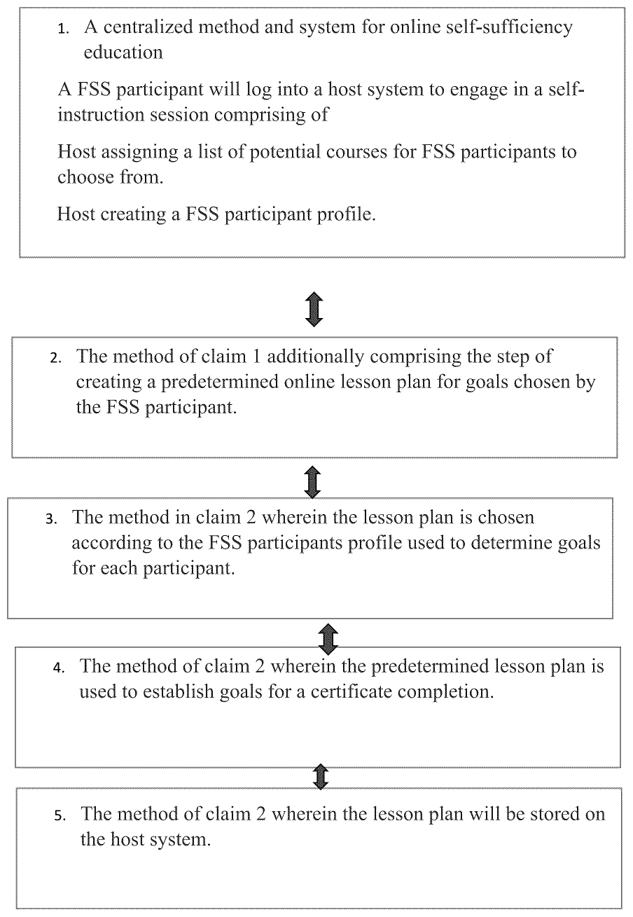

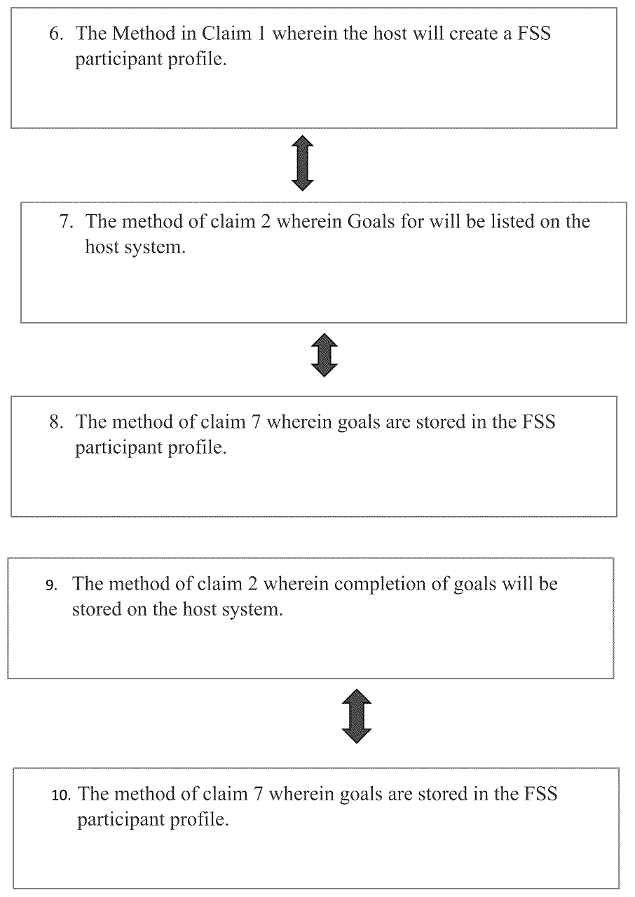

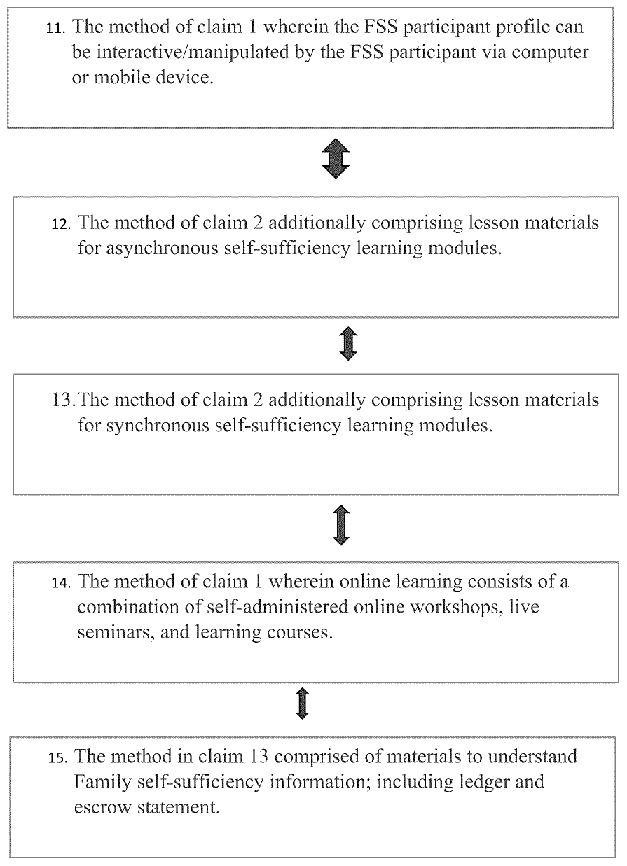

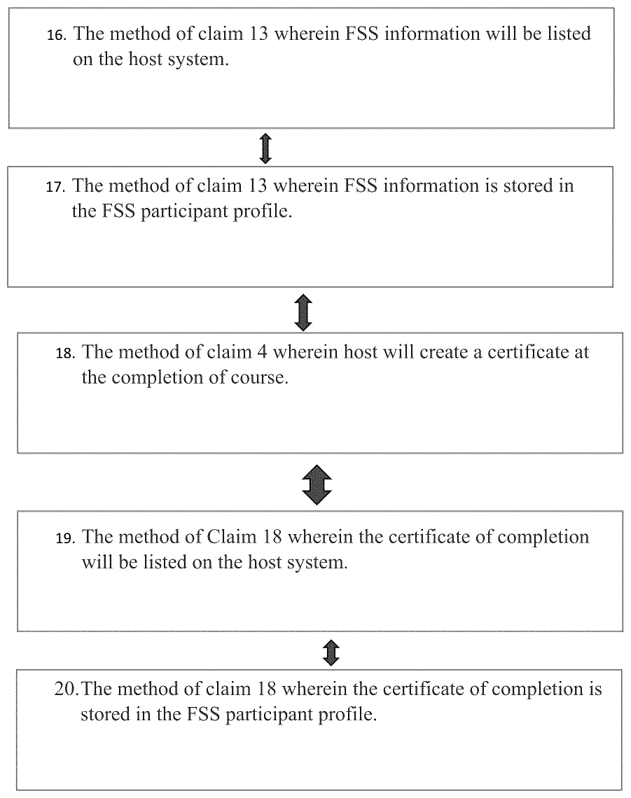

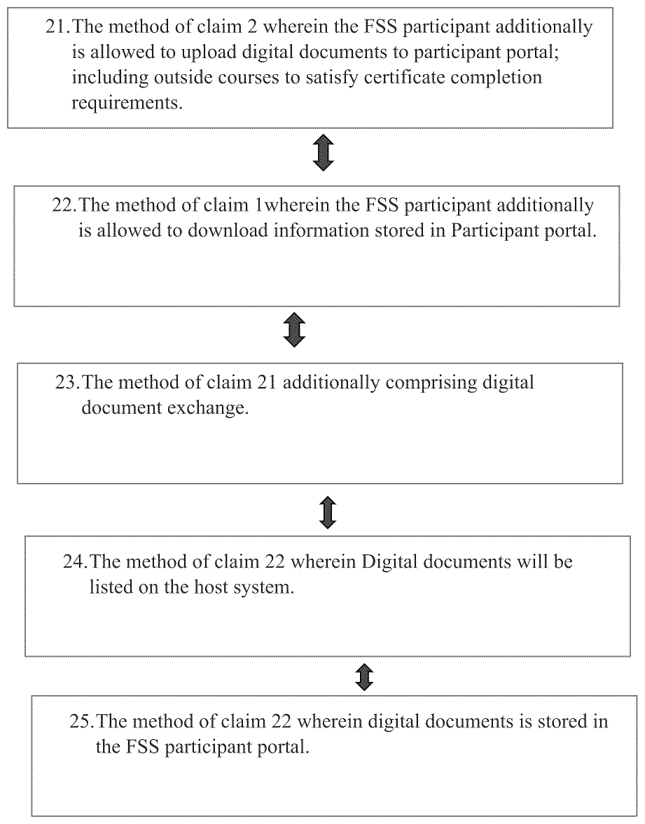

### CROSS REFERENCE TO RELATED APPLICATIONS

This application Claims benefit of U.S. provisional application Ser. No. 63/481,864.

A centralized method and system for online self-sufficiency education. Upon selection of a chosen self-sufficiency path which will include a combination of several paths for completion. This system will be accessible via Mobile or Desktop option for quick access to modules and materials for learning. The successful completion of the self-sufficiency module will result in a certificate of completion for each completed module until the entire course is concluded (the Individual will then receive a full certificate of completion). The learning modules will consist of reading, visual, aural, logical, social, solitary, verbal, physical learning methods appealing to the various learning styles of the individual to engage learning. There will be means of online workshops, live seminars, and learning courses that will guide, advise, and educate individuals and families to self-sufficiency.

### BACKGROUND

The Family Self-Sufficiency (FSS) program is a United States Department of Housing and Urban Development (HUD) designed program to provide participants receiving Housing Choice Voucher Program assistance in becoming self-sufficient and independent of public assistance. The program serves families who volunteer to participate by providing case management and referral to community supportive services. Each jurisdiction within the United States continues to maintain separate Action Plans to administer the program.

The Program has grown steadily, showing marked growth since its establishment, which coincided with the introduction of the Welfare to Work voucher program. This marked history of growth and planned future program enhancement requires that the policies and procedures be reexamined in order to best serve the growing numbers of families that desire the same outcomes as the FSS program seeks to provide—the independence from governmental assistance and the economic empowerment of their families.

What is needed is a program that is technologically advanced to allow the FSS participants to optimize job search, program placement, retention, and advancement for self-sufficiency. Using a computer implemented system method to administer the program would free up participant time as well as company time. The use of online learning for FSS programs will increase the time of graduation and provide access to the program resources in any place at any time. This will make it convenient for FSS participants to track their progress while providing transparency between FSS coordinators and FSS participants throughout completion of the program.

1. A centralized method and system for online self-sufficiency education
A FSS participant will log into a host system to engage in a self-instruction session comprising of
Host assigning a list of potential courses for FSS participants to choose from.
Host creating a FSS participant profile.

2. The method of claim 1 additionally comprising the step of creating a predetermined online lesson plan for goals chosen by the FSS participant.

3. The method in claim 2 wherein the lesson plan is chosen according to the FSS participants profile used to determine goals for each participant.

4. The method of claim 2 wherein the predetermined lesson plan is used to establish goals for a certificate completion.

5. The method of claim 2 wherein the lesson plan will be stored on the host system.

6. The Method in claim 1 wherein the host will create a FSS participant profile.

7. The method of claim 2 wherein Goals for will be listed on the host system.

8. The method of claim 7 wherein goals are stored in the FSS participant profile.

9. The method of claim 2 wherein completion of goals will be stored on the host system.

10. The method of claim 7 wherein goals are stored in the FSS participant profile.

11. The method of claim 1 wherein the FSS participant profile can be interactive/manipulated by the FSS participant via computer or mobile device.

12. The method of claim 2 additionally comprising lesson materials for asynchronous self-sufficiency learning modules.

13. The method of claim 2 additionally comprising lesson materials for synchronous self-sufficiency learning modules.

14. The method of claim 1 wherein online learning consists of a combination of self-administered online workshops, live seminars, and learning courses.

15. The method in claim 13 comprised of materials to understand Family self-sufficiency information; including ledger and escrow statement.

16. The method of claim 13 wherein FSS information will be listed on the host system.

17. The method of claim 13 wherein FSS information is stored in the FSS participant profile.

18. The method of claim 4 wherein host will create a certificate at the completion of course.

19. The method of claim 18 wherein the certificate of completion will be listed on the host system.

20. The method of claim 18 wherein the certificate of completion is stored in the FSS participant profile.

21. The method of claim 2 wherein the FSS participant additionally is allowed to upload digital documents to participant portal; including outside courses to satisfy certificate completion requirements.

22. The method of claim 1 wherein the FSS participant additionally is allowed to download information stored in Participant portal.

23. The method of claim 21 additionally comprising digital document exchange.

24. The method of claim 22 wherein Digital documents will be listed on the host system.

25. The method of claim 22 wherein digital documents is stored in the FSS participant portal.
